(19) United States
(12) Patent Application Publication
(10) Pub. No.: US 2025/0158418 A1
(43) Pub. Date: May 15, 2025

(54) DC POWER DISTRIBUTION SYSTEM

(71) Applicant: Mitsubishi Electric Corporation, Chiyoda-ku, Tokyo (JP)

(72) Inventors: Yusuke KATO, Chiyoda-ku, Tokyo (JP); Kenichi FUKUNO, Chiyoda-ku, Tokyo (JP)

(73) Assignee: Mitsubishi Electric Corporation, Chiyoda-ku,Tokyo (JP)

(21) Appl. No.: 18/837,314

(22) PCT Filed: Jun. 17, 2022
(86) PCT No.: PCT/JP2022/024275

§ 371 Date: Aug. 9, 2024

(51) Int. Cl. H02J 5/00; H02J 3/00; H02J 3/38

(52) U.S. Cl. CPC H02J 5/00; H02J 3/003; H02J 3/004; H02J 3/38

(57) ABSTRACT

Provided is a DC power distribution system in which power loss is small even when DC grid voltage and load supply voltage are greatly different. This DC power distribution system includes an AC-DC converter, a first sensor which detects generated power of a power generation device, a load DC-DC converter, a second sensor which detects load supply power, and a switchover command generation unit which switches between two operation modes of the AC-DC converter. In an operation mode 1, voltage of a DC grid is set to be higher than a value obtained by multiplying a voltage effective value of AC power by the square root of 2. When generated power is smaller than load supply power, the switchover command generation unit reduces voltage of the DC grid and switches the operation mode from the operation mode 1 to an operation mode 2.

### TECHNICAL FIELD

The present disclosure relates to a DC power distribution system.

### BACKGROUND ART

In recent years, in general households, office buildings, factories, stations, and the like, DC power supplies such as a power storage battery and power generation devices such as a solar power generation device have been increasingly installed for coping with power outage of an AC power grid and utilizing natural energy. A DC power distribution system converts AC power from an AC power grid to DC power by an AC-DC converter (Alternating Current-Direct Current converter) and outputs the DC power to a DC grid, and also, supplies DC power from a DC power supply, a solar power generation device, and the like to the DC grid. Then, the DC power distribution system supplies power from the DC grid to a load. In the DC power distribution system, the number of times of power conversion in charging a DC power supply and supplying power to a load is smaller than in an AC power distribution system, and therefore power loss due to power conversion can be reduced. In addition, in the DC power distribution system, an AC-DC converter for converting AC to DC need not be provided on the load side, so that economic efficiency is improved.

In general, in such a DC power distribution system, DC grid voltage, DC power supply voltage, and load supply voltage are different from each other. In this case, the DC grid voltage is set to be higher than the DC power supply voltage and the load supply voltage. Therefore, as necessary, voltage of DC power is stepped down by DC-DC converters (Direct Current-Direct Current converters) provided between the DC grid and the DC power supply and between the DC grid and the load. Here, as the voltage step-down ratio in the DC-DC converter becomes greater, power loss due to stepping down of voltage becomes greater, thus leading to reduction in power usage efficiency.

As a conventional DC power distribution system that enables reduction in the voltage step-down ratio, proposed is a DC power distribution system in which DC grid voltage is periodically changed, power is stored in a power storage battery provided for each load while voltage corresponding to the own load supply voltage of the load is applied, and the stored power is used (see, for example, Patent Document 1).

### CITATION LIST

### Patent Document

Patent Document 1: Japanese Laid-Open Patent Publication No. 2008-253118

### SUMMARY OF THE INVENTION

### Problem to be Solved by the Invention

The DC power distribution system may have a reverse power flow function of converting surplus power of a solar power generation device or the like to AC power and outputting the AC power to an AC power grid. In order to perform stable reverse power flow operation in the DC power distribution system, it is necessary to set DC grid voltage at voltage sufficiently higher than voltage of an AC power grid. In the conventional DC power distribution system, even if the DC grid voltage set at high voltage for reverse power flow operation is periodically changed, a voltage step-down ratio might not be sufficiently reduced. Thus, in the conventional DC power distribution system, the effect of reducing power loss due to stepping down of voltage becomes small.

The present disclosure has been made to solve the above problem, and an object of the present disclosure is to provide a DC power distribution system in which power loss is small even in a case where DC grid voltage and load supply voltage are greatly different from each other.

### Means to Solve the Problem

A DC power distribution system according to the present disclosure includes: an AC-DC converter having a forward power flow function of converting AC power inputted from a power grid to DC power and outputting the DC power to a DC grid, and a reverse power flow function of converting DC power from the DC grid to AC power and outputting the AC power to the power grid; a first sensor which detects generated power of a power generation device connected to the DC grid; a load DC-DC converter which supplies power to a load connected to the DC grid; a second sensor which detects power supplied from the DC grid to the load DC-DC converter and the load; and a switchover command generation unit which generates a command for switching between two operation modes of the AC-DC converter. The two operation modes are an operation mode 1 in which the reverse power flow function of the AC-DC converter is enabled, and an operation mode 2 in which the reverse power flow function of the AC-DC converter is disabled. In the operation mode 1, voltage of the DC grid is set to be higher than a value obtained by multiplying a voltage effective value of the AC power by a square root of 2. In a case where the generated power of the power generation device detected by the first sensor is smaller than the power supplied to the load DC-DC converter and the load, which is detected by the second sensor, the switchover command generation unit reduces the voltage of the DC grid and switches the operation mode of the AC-DC converter from the operation mode 1 to the operation mode 2.

### Effect of the Invention

In the DC power distribution system according to the present disclosure, in a case where the generated power of the power generation device detected by the first sensor is smaller than the power supplied to the load DC-DC converter and the load, which is detected by the second sensor, the voltage of the DC grid is reduced and the operation mode of the AC-DC converter is switched from the operation mode 1 to the operation mode 2. Thus, even in a case where the DC grid voltage and the load supply voltage are greatly different from each other, power loss can be reduced.

### BRIEF DESCRIPTION OF THE DRAWINGS

FIG. 1 is a configuration diagram of a DC power distribution system according to embodiment 1.

FIG. 2 is a configuration diagram of an AC-DC converter according to embodiment 1.

FIG. 3 is a configuration diagram of a DC power supply DC-DC converter according to embodiment 1.

FIG. 4 illustrates operation of an autonomous operation control unit in embodiment 1.

FIG. 5 is a configuration diagram of a load DC-DC converter according to embodiment 1.

FIG. 6 illustrates power consumption in an office building and generated power of a solar power generation device according to embodiment 1.

FIG. 7 is a flowchart showing a switchover process for an operation mode in the DC power distribution system according to embodiment 1.

FIG. 8 illustrates the switchover process for the operation mode in the DC power distribution system according to embodiment 1.

FIG. 9 illustrates the switchover process for the operation mode in the DC power distribution system according to embodiment 1.

FIG. 10 is a flowchart showing a switchover process for the operation mode in the DC power distribution system according to embodiment 1.

FIG. 11 is a configuration diagram of a DC power distribution system according to embodiment 2.

FIG. 12 is a configuration diagram of a DC power distribution system according to embodiment 3.

FIG. 13 shows a hardware configuration for implementing a switchover command generation unit according to embodiments 1 to 3.

### DESCRIPTION OF EMBODIMENTS

Hereinafter, a DC power distribution system according to embodiments of the present disclosure will be described in detail with reference to the drawings. In the drawings, the same reference characters denote the same or corresponding parts.

### Embodiment 1

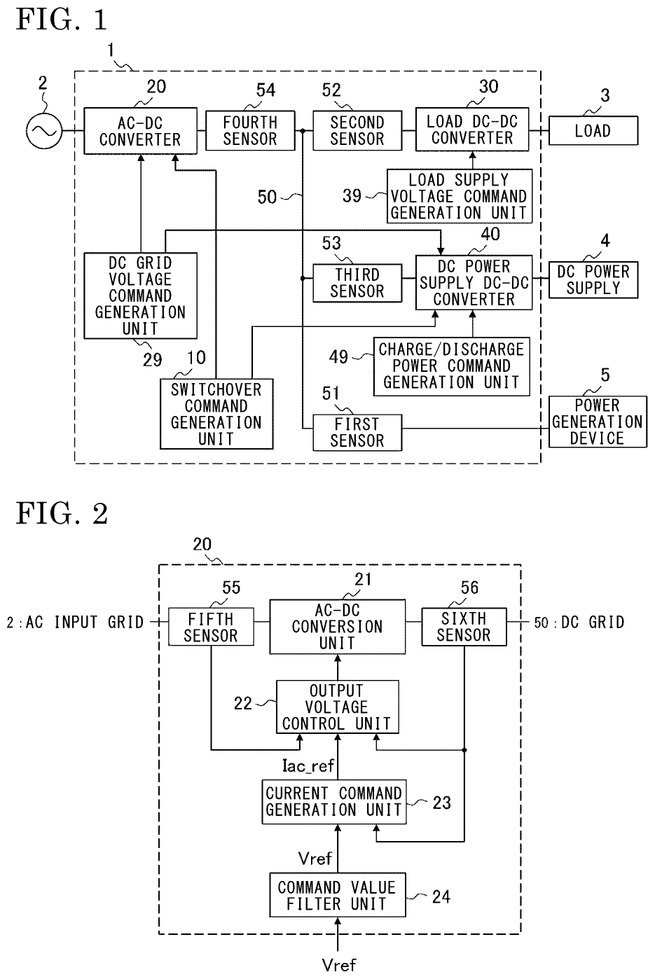

FIG. 1 is a configuration diagram of a DC power distribution system according to embodiment 1. A DC power distribution system 1 of the present embodiment is provided between an AC input grid 2, and a load 3, a DC power supply 4, and a power generation device 5. Here, the AC input grid 2 is an AC grid for supplying power to the DC power distribution system 1 via AC reception equipment from a commercial power grid operated by an electric power company. The load 3 is an electric device driven with DC power. The DC power supply 4 is a power storage battery or the like which is capable of charging and discharging. The power generation device 5 is a power generation device which outputs DC power, e.g., a solar power generation device which performs power generation using renewable energy. The power generation device 5 includes a power generation unit using renewable energy, and a power conversion unit. The power generation device 5 can supply DC power to the DC power distribution system 1.

The DC power distribution system 1 of the present embodiment includes an AC-DC converter 20 which converts AC power inputted from the AC input grid 2 to DC power and outputs the DC power to a DC grid 50, a load DC-DC converter 30 provided between the DC grid 50 and the load 3, a DC power supply DC-DC converter 40 provided between the DC grid 50 and the DC power supply 4, and a switchover command generation unit 10. The load DC-DC converter 30 converts DC power from the DC grid 50 to load supply voltage for the load 3 and supplies the resultant power to the load 3. The load 3 is an electric device driven with DC power and includes one or a plurality of electric devices. Power consumption of the load 3 varies in accordance with the operation state of the load 3, but hardly varies if the operation state is constant. Therefore, during a period in which the operation state of the load 3 does not vary, voltage to be supplied from the load DC-DC converter 30 may be adjusted so as to minimize power loss in a power supply circuit and an input interface unit of the load 3, whereby power consumption of the load 3 can be minimized and economic efficiency can be improved. Preferably, the load supply voltage is set within a limitation range of input voltage prescribed for each load, so that operation of the load is not hampered.

The DC power supply DC-DC converter 40 converts DC power of the DC grid 50 to charge voltage for the DC power supply 4 and supplies the resultant power to the DC power supply 4. Also, the DC power supply DC-DC converter 40 converts discharge power from the DC power supply 4 to voltage for the DC grid 50 and outputs the resultant power to the DC grid 50. The switchover command generation unit 10 controls the AC-DC converter 20 and the DC power supply DC-DC converter 40.

An AC electric path from the AC input grid 2 to the AC-DC converter 20 is formed as a single-phase three-line type or a three-phase three-line type, for example. In FIG. 1, the AC electric path is shown as a single line. The DC grid 50 is formed as a DC electric path having a pair of a positive electric wire and a negative electric wire, for example. In FIG. 1, the DC grid 50 is shown as a single line.

A first sensor 51 for detecting generated power of the power generation device 5 is provided between the power generation device 5 and the DC grid 50. A second sensor 52 for detecting load power to be supplied to the load DC-DC converter 30 and the load 3 is provided between the load DC-DC converter 30 and the DC grid 50. A third sensor 53 for detecting charge/discharge power which is supplied to/from the DC power supply DC-DC converter 40 and the DC power supply 4 is provided between the DC power supply DC-DC converter 40 and the DC grid 50. A fourth sensor 54 for detecting output power from the AC-DC converter 20 is provided between the AC-DC converter 20 and the DC grid 50. The first sensor 51, the second sensor 52, the third sensor 53, and the fourth sensor 54 detect powers from currents and voltages. The powers detected by the first sensor 51, the second sensor 52, the third sensor 53, and the fourth sensor 54 are sent to the switchover command generation unit 10.

A DC grid voltage command generation unit 29 for generating a DC grid voltage command is connected to the AC-DC converter 20. A load supply voltage command generation unit 39 for generating a load supply voltage command is connected to the load DC-DC converter 30. A charge/discharge power command generation unit 49 for generating a charge/discharge power command is connected to the DC power supply DC-DC converter 40. The DC grid voltage command generation unit 29, the load supply voltage command generation unit 39, and the charge/discharge power command generation unit 49 may be respectively included in the AC-DC converter 20, the load DC-DC converter 30, and the DC power supply DC-DC converter 40, or may be provided to one controller.

The DC power distribution system 1 is a system applied to a general household, an office building, a factory, a station, or the like, for example. The AC input grid is a commercial power grid operated by an electric power company. The DC power supply and the power generation device are, for example, a power storage battery and a solar power generation device, respectively. Therefore, devices composing the DC power distribution system 1 may be provided in a distributed manner. For example, the AC-DC converter 20 may be provided at a building A, and the DC power supply DC-DC converter 40 and the DC power supply 4 may be provided at another building B.

The DC power distribution system 1 is capable of performing power-running operation (hereinafter, referred to as forward power flow operation) of supplying AC power inputted from the AC input grid 2, to the load 3 and the DC power supply 4 through the DC grid 50, and regeneration operation (hereinafter, referred to as reverse power flow operation) of supplying DC power inputted from the DC power supply 4 and the power generation device 5, to the AC input grid 2 through the DC grid 50. In the DC power distribution system 1, forward power flow operation and reverse power flow operation are controlled by the AC-DC converter 20.

In the DC power distribution system 1, for performing reverse power flow operation, voltage of the DC grid 50 is set to be sufficiently higher than a value obtained by multiplying the voltage effective value of the AC input grid 2 by the square root of 2. In addition, voltage of the DC grid 50 is set to be higher than the load supply voltage of the load 3 and the charge/discharge voltage of the DC power supply 4. For example, the voltage effective value of the AC input grid 2 is set at 400 V, the voltage of the DC grid 50 is set at 740 V, the load supply voltage of the load 3 is set at 340 V, and the charge/discharge voltage of the DC power supply 4 is set at 300 V. The load 3 and the DC power supply 4 are supplied with powers at voltages stepped down from the voltage of the DC grid 50 by the load DC-DC converter 30 and the DC power supply DC-DC converter 40, respectively.

The switchover command generation unit 10 controls the AC-DC converter 20 and the DC power supply DC-DC converter 40 on the basis of powers inputted from the first sensor 51, the second sensor 52, the third sensor 53, and the fourth sensor 54. Here, a state in which reverse power flow operation of the AC-DC converter 20 is enabled is referred to as an operation mode 1, and a state in which reverse power flow operation of the AC-DC converter 20 is disabled is referred to as an operation mode 2. That is, the operation mode 1 is a state in which the voltage of the DC grid 50 is set to be sufficiently higher than the value obtained by multiplying the voltage effective value of the AC input grid 2 by the square root of 2, and the operation mode 2 is a state in which the voltage of the DC grid 50 is set to be lower than lower limit voltage in the operation mode 1. The lower limit voltage in the operation mode 1 is determined by adding a margin including sensor error, voltage utilization of the AC-DC converter 20, and the like to a value obtained by multiplying the maximum voltage effective value of the AC input grid 2 by the square root of 2. The switchover command generation unit 10 generates a switchover command for switching between the operation mode 1 and the operation mode 2, and sends the switchover command to the AC-DC converter 20 and the DC power supply DC-DC converter 40. In addition, the switchover command generation unit 10 sends a change command for parameters such as a control threshold and a voltage command value accompanying switchover of the operation mode.

FIG. 2 is a configuration diagram of the AC-DC converter according to the present embodiment. The AC-DC converter 20 of the present embodiment includes an AC-DC conversion unit 21 which performs power conversion, a fifth sensor 55 which detects current and voltage of the AC input grid 2, a sixth sensor 56 which detects current and voltage of the DC grid 50, an output voltage control unit 22 which controls output voltage of the AC-DC conversion unit 21, a current command generation unit 23 which generates a current command value Iac_ref for the AC-DC conversion unit 21, and a command value filter unit 24 which processes a DC grid voltage command Vref. In a case where the AC input grid 2 and the AC-DC conversion unit 21 need to be isolated from each other, an isolation transformer needs to be provided between the AC input grid 2 and the AC-DC conversion unit 21. The fourth sensor 54 shown in FIG. 1 may be used as a substitute for the sixth sensor 56.

The DC grid voltage command Vref is inputted from the DC grid voltage command generation unit 29. In a case where the variation width of the DC grid voltage command Vref is great, directly using the DC grid voltage command Vref might cause overshoot of voltage of the DC grid 50 outputted from the AC-DC conversion unit 21. The command value filter unit 24 is provided for suppressing sharp variation in the inputted DC grid voltage command Vref. The command value filter unit 24 is, for example, a low-pass filter, and can suppress sharp variation in the DC grid voltage command Vref. The time constant of the low-pass filter is set in advance in accordance with the control characteristic of the AC-DC conversion unit 21. In a case where control response of the AC-DC conversion unit 21 is small and thus overshoot is less likely to occur on the output voltage, the command value filter unit 24 may be omitted. The command value filter unit 24 may include a limiter for limiting the upper/lower limit of the DC grid voltage command Vref.

The DC grid voltage command Vref may be set by a user of the DC power distribution system 1 via a user interface, may be set by a host control device (external controller) which performs energy management control, or may be set along with switchover between the operation mode 1 and the operation mode 2 performed by the switchover command generation unit described later.

The current command generation unit 23 generates the current command value Iac_ref on the basis of the DC grid voltage command Vref that has passed through the command value filter unit 24 and the voltage of the DC grid 50 detected by the sixth sensor 56. The current command generation unit 23 may generate the current command value Iac_ref that has undergone limiter processing for limiting the upper/lower limit thereof. The current command generation unit 23 may generate a power command value instead of the current command value.

The output voltage control unit 22 controls voltage that the AC-DC conversion unit 21 outputs to the AC input grid 2, on the basis of the current command value Iac_ref generated by the current command generation unit 23, current and voltage of the AC input grid 2 detected by the fifth sensor 55, and current and voltage of the DC grid 50 detected by the sixth sensor 56.

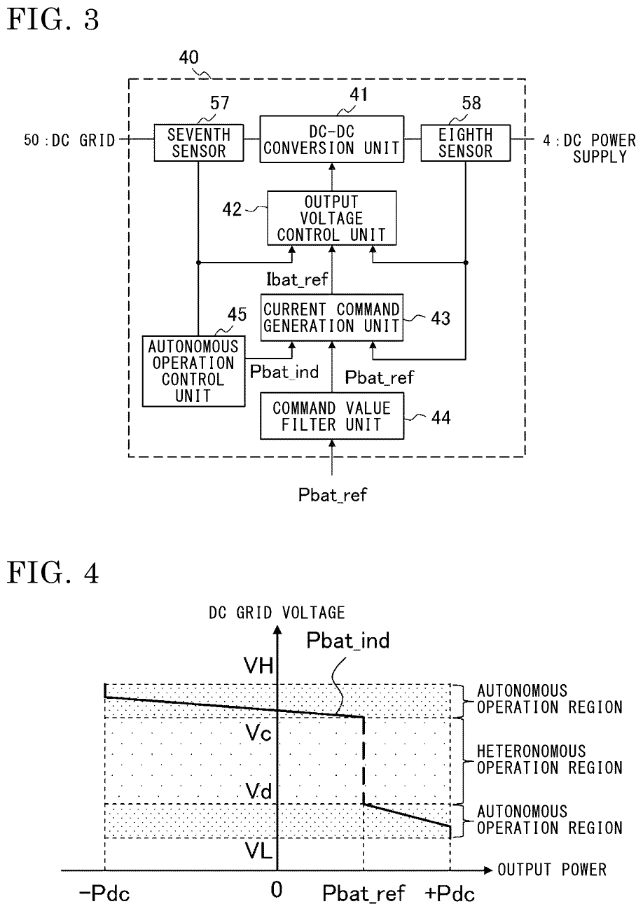

FIG. 3 is a configuration diagram of the DC power supply DC-DC converter according to the present embodiment. The DC power supply DC-DC converter 40 of the present embodiment includes a DC-DC conversion unit 41 which performs power conversion, a seventh sensor 57 which detects current and voltage of the DC grid 50, an eighth sensor 58 which detects current and voltage on the DC power supply 4 side, an output voltage control unit 42 which controls output voltage of the DC-DC conversion unit 41, a current command generation unit 43 which generates a current command value Ibat_ref for the DC-DC conversion unit 41, a command value filter unit 44 which processes a charge/discharge power command Pbat_ref, and an autonomous operation control unit 45. The third sensor 53 shown in FIG. 1 may be used as a substitute for the seventh sensor 57.

The charge/discharge power command Pbat_ref is inputted from the charge/discharge power command generation unit 49. The command value filter unit 44 is, for example, a low-pass filter, and can suppress sharp variation in the charge/discharge power command Pbat_ref. The time constant of the low-pass filter is set in advance in accordance with the control characteristic of the DC-DC conversion unit 41. In a case where control response of the DC-DC conversion unit 41 is small and thus overshoot is less likely to occur on the output voltage, the command value filter unit 44 may be omitted. The command value filter unit 44 may include a limiter for limiting the upper/lower limit of the charge/discharge power command Pbat_ref.

The charge/discharge power command Pbat_ref is determined in accordance with the charge/discharge capability and the remaining capacity of the DC power supply 4, and the like. For example, in a case where the DC power supply 4 is formed by a secondary battery, the charge/discharge power command Pbat_ref is determined in accordance with the state of charge (SOC) and the state of health (SOH) of the secondary battery, and the like.

The autonomous operation control unit 45 generates an autonomous operation charge/discharge power command Pbat_ind for switching to autonomous operation and performing autonomous operation, on the basis of current and voltage of the DC grid detected by the seventh sensor 57. The autonomous operation control unit 45 sends the generated autonomous operation charge/discharge power command Pbat_ind to the current command generation unit 43. Here, the autonomous operation means that the autonomous operation charge/discharge power command Pbat_ind is being generated for the DC-DC conversion unit 41 to keep the voltage of the DC grid in a target voltage range and the DC-DC conversion unit 41 is outputting power on the basis of the command. Meanwhile, heteronomous operation means that the DC-DC conversion unit 41 is outputting power on the basis of the charge/discharge power command Pbat_ref received from an external controller or the like. Operation of the autonomous operation control unit 45 will be described later.

The current command generation unit 43 generates the current command value Ibat_ref on the basis of the charge/discharge power command Pbat_ref that has passed through the command value filter unit 44, the autonomous operation charge/discharge power command Pbat_ind generated by the autonomous operation control unit 45, and current and voltage on the DC power supply 4 side detected by the eighth sensor 58. The current command generation unit 43 may generate the current command value Ibat_ref that has undergone limiter processing for limiting the upper/lower limit thereof.

The output voltage control unit 42 controls voltage that the DC-DC conversion unit 41 outputs, on the basis of the current command value Ibat_ref generated by the current command generation unit 43, current and voltage of the DC grid 50 detected by the seventh sensor 57, and current and voltage on the DC power supply 4 side detected by the sixth sensor 56.

FIG. 4 illustrates operation of the autonomous operation control unit in the present embodiment. In FIG. 4, the vertical axis indicates voltage of the DC grid 50, and the horizontal axis indicates output power of the DC-DC conversion unit 41. On the horizontal axis, power outputted from the DC-DC conversion unit 41 to the DC grid 50 side is defined as positive. Therefore, on the minus side of the horizontal axis, the DC-DC conversion unit 41 outputs (charges) power to the DC power supply 4 side. In FIG. 4, VH is upper limit stop voltage, VL is lower limit stop voltage, and Vc and Vd are upper and lower limits of threshold voltage at which the DC-DC conversion unit 41 starts autonomous operation. In addition, +Pdc is maximum output power that the DC-DC conversion unit 41 outputs to the DC grid 50 side, and −Pdc is maximum output power that the DC-DC conversion unit 41 outputs to the DC power supply 4 side.

The autonomous operation charge/discharge power command Pbat_ind that the autonomous operation control unit 45 generates is set as follows. The autonomous operation charge/discharge power command Pbat_ind is set so as to become equal to the charge/discharge power command Pbat_ref at Vc and Vd which are the upper limit and the lower limit of the threshold voltage. In a voltage region lower than the threshold voltage Vd, the autonomous operation charge/discharge power command Pbat_ind is set so as to increase output power to the DC grid as the DC grid voltage decreases, in order to prevent reduction in the DC grid voltage. Here, the maximum value of the autonomous operation charge/discharge power command Pbat_ind is set at the maximum output power +Pdc of the DC-DC conversion unit 41. In a voltage region higher than the threshold voltage Vc, the autonomous operation charge/discharge power command Pbat_ind is set so as to decrease output power to the DC grid as the DC grid voltage increases, in order to prevent increase in the DC grid voltage. In a case where the DC grid voltage increases even though the output power to the DC grid is decreased, the autonomous operation charge/discharge power command Pbat_ind is set so that the output power of the DC-DC conversion unit 41 becomes minus, i.e., the DC power supply 4 is charged with power.

In a case where voltage of the DC grid 50 detected by the seventh sensor 57 is not smaller than Vd and not greater than Vc, the current command generation unit 43 generates the current command value Ibat_ref on the basis of the charge/discharge power command Pbat_ref sent from the command value filter unit 44. The voltage of the DC grid not smaller than Vd and not greater than Vc is referred to as steady voltage. Therefore, when the voltage of the DC grid is the steady voltage, the DC-DC conversion unit 41 outputs power on the basis of the charge/discharge power command Pbat_ref.

In a case where the voltage of the DC grid 50 detected by the seventh sensor 57 is smaller than Vd or greater than Vc, the autonomous operation control unit 45 sends the aforementioned autonomous operation charge/discharge power command Pbat_ind to the current command generation unit 43. The current command generation unit 43 generates the current command value Ibat_ref on the basis of the autonomous operation charge/discharge power command Pbat_ind sent from the autonomous operation control unit 45. Therefore, when the voltage of the DC grid is not the steady voltage, the DC-DC conversion unit 41 outputs power on the basis of the autonomous operation charge/discharge power command Pbat_ind. As shown in FIG. 4, regions in which the DC-DC conversion unit 41 outputs power on the basis of the autonomous operation charge/discharge power command Pbat_ind, are shown as autonomous operation regions.

That is, in a case where the voltage of the DC grid 50 is not smaller than Vd and not greater than Vc, the DC-DC conversion unit 41 performs heteronomous operation on the basis of the charge/discharge power command Pbat_ref. In a case where the voltage of the DC grid 50 is smaller than Vd or greater than Vc, the DC-DC conversion unit 41 performs autonomous operation on the basis of the autonomous operation charge/discharge power command Pbat_ind.

In a case where the voltage of the DC grid 50 is greater than the upper limit stop voltage VH or smaller than the lower limit stop voltage VL even though the DC-DC conversion unit 41 continues outputting the maximum output power through autonomous operation, the autonomous operation control unit 45 stops operation of the DC power distribution system 1.

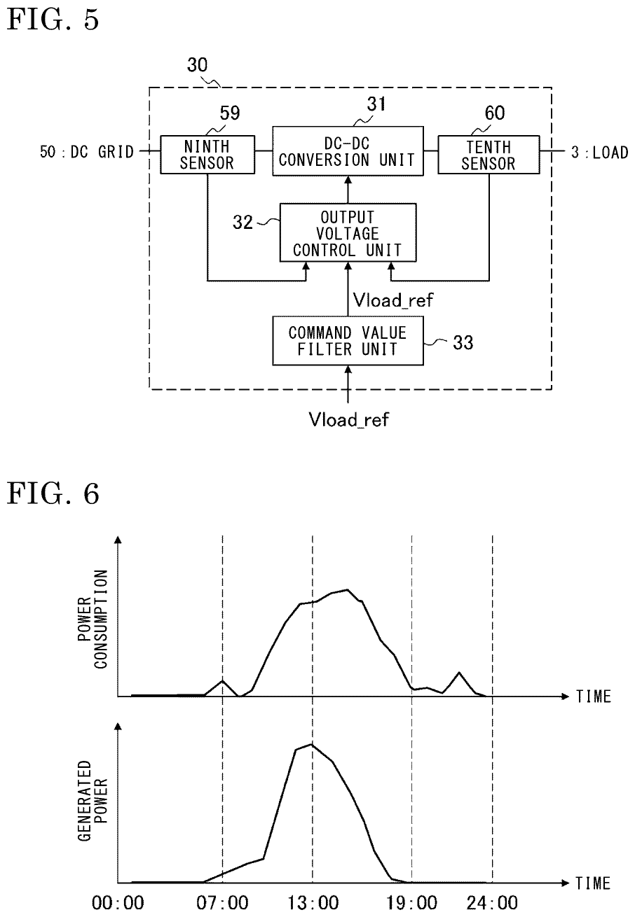

FIG. 5 is a configuration diagram of the load DC-DC converter according to the present embodiment. The load DC-DC converter 30 of the present embodiment includes a DC-DC conversion unit 31 which performs power conversion, a ninth sensor 59 which detects voltage and current of the DC grid 50, a tenth sensor 60 which detects current and voltage on the load 3 side, an output voltage control unit 32 which controls output voltage of the DC-DC conversion unit 31, and a command value filter unit 33 which processes a load supply voltage command Vload_ref. The second sensor 52 shown in FIG. 1 may be used as a substitute for the ninth sensor 59.

The load supply voltage command Vload_ref is inputted from the load supply voltage command generation unit 39. The command value filter unit 33 is, for example, a low-pass filter, and can suppress sharp variation in the load supply voltage command Vload_ref. The time constant of the low-pass filter is set in advance in accordance with the control characteristic of the DC-DC conversion unit 31. In a case where control response of the DC-DC conversion unit 31 is small and thus overshoot is less likely to occur on the output voltage, the command value filter unit 33 may be omitted. The command value filter unit 33 may include a limiter for limiting the upper/lower limit of the load supply voltage command Vload_ref.

The load supply voltage command Vload_ref is determined in accordance with the rated voltage of the load 3, the voltage reduction amount on wiring to the load 3, and the like.

The output voltage control unit 32 controls voltage that the DC-DC conversion unit 31 outputs, on the basis of the load supply voltage command Vload_ref that has passed through the command value filter unit 33, current and voltage of the DC grid detected by the ninth sensor 59, and current and voltage on the load 3 side detected by the tenth sensor 60.

From the standpoint of energy saving, the DC power distribution system 1 is designed so that the amount of power purchased from the AC grid becomes small. In addition, normal operation of the DC power distribution system 1 is performed so that the amount of power purchased from the AC grid becomes small. Therefore, in the DC power distribution system 1, even in a case of forward power flow operation, most of power required by the load 3 is supplied from the power generation device 5 and the DC power supply 4 so that power supplied from the AC input grid 2 becomes small, and reverse power flow operation is performed frequently. Meanwhile, in a case where the power generation device 5 is a solar power generation device, generated power is almost zero in cloudy weather and during the night. In a condition in which the power generation device 5 cannot generate power, the DC power distribution system 1 mainly needs to supply power to the load 3 and supply charge power to the DC power supply 4, from the AC input grid 2.

FIG. 6 illustrates an example of temporal transitions of power consumption in a general office building and generated power of a solar power generation device during one day. In FIG. 6, the upper graph shows power consumption in the office building, and the lower graph shows generated power of the solar power generation device. Power consumption in the office building corresponds to power consumption of the load 3 in the DC power distribution system 1 of the present embodiment. As shown in FIG. 6, power consumption in the office building has a feature that power consumption is great in the daytime and small during the night. This feature coincides with the feature of generated power of the solar power generation device. Therefore, in the DC power distribution system 1 of the present embodiment, during the night, reverse power flow operation need not be performed and load power is small, and therefore it becomes unnecessary to keep the DC grid voltage high. In general, power losses in an AC-DC converter and a DC-DC converter become smaller as the step-up/down ratio becomes smaller. Therefore, if the DC grid voltage during the night is set to be lower than the DC grid voltage in the daytime, loss in the entire DC power distribution system 1 is expected to be reduced. Here, the load DC-DC converter and the load can be collectively regarded as a constant power load, and therefore, in a case where the load power is low, even if the DC grid voltage is reduced and thus current is increased, the rated current of wiring can be prevented from being exceeded.

Next, a procedure for switchover of the operation mode in the DC power distribution system 1 of the present embodiment will be described. In the following description, it is assumed that the DC power supply 4 is formed by a secondary battery.

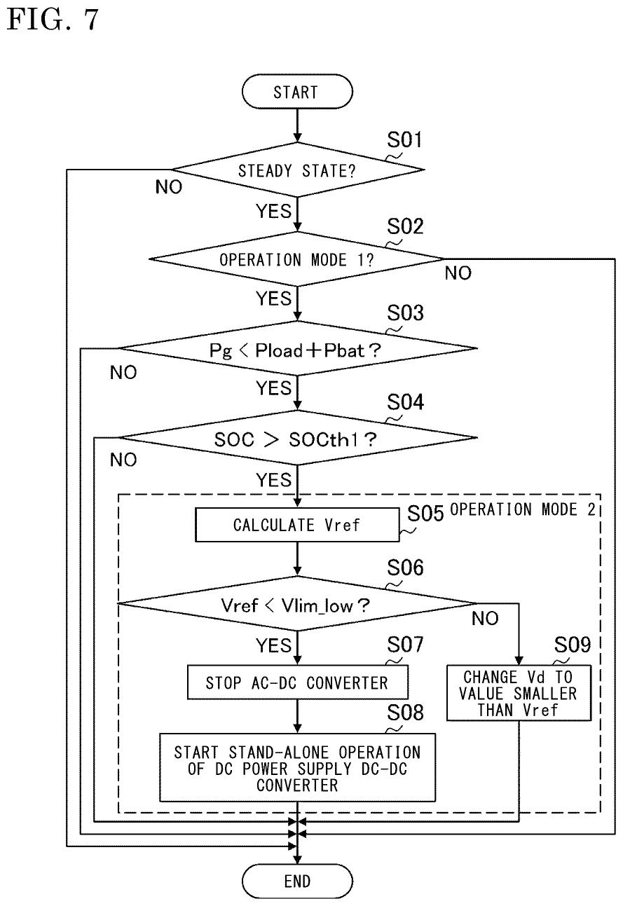

FIG. 7 is a flowchart showing a switchover process for the operation mode in the DC power distribution system 1 of the present embodiment. The switchover process for the operation mode shown in FIG. 7 is a process for switching from the operation mode 1 to the operation mode 2. After the process is started, in step S01, the switchover command generation unit 10 determines whether or not the DC power distribution system 1 is in a steady state. In step S01, if the DC power distribution system 1 is in a non-steady state such as during starting up or shutting down (NO), the switchover command generation unit 10 ends the switchover process. In step S01, if the DC power distribution system 1 is in a steady state (YES), the switchover command generation unit 10 proceeds to step S02. Here, the steady state is a state in which the DC power distribution system 1 is normally operating while not in a transient operation state, and is performing forward power flow operation or reverse power flow operation.

In step S02, the switchover command generation unit 10 determines whether or not the operation mode of the DC power distribution system 1 is the operation mode 1. The determination in step S02 can be performed by reading the operation state of the DC power distribution system 1 stored in a storage unit or the like. In step S02, if the operation mode of the DC power distribution system 1 is not the operation mode 1 (NO), the switchover command generation unit 10 ends the switchover process. In step S02, if the operation mode of the DC power distribution system 1 is the operation mode 1 (YES), the switchover command generation unit 10 proceeds to step S03.

In step S03, the switchover command generation unit 10 determines whether or not the sum of load power Pload supplied to the load DC-DC converter 30 and the load 3, which is detected by the second sensor 52, and charge/discharge power Pbat supplied to the DC power supply DC-DC converter 40 and the DC power supply 4, which is detected by the third sensor 53, is greater than generated power Pg of the power generation device 5 detected by the first sensor 51. In step S03, if the sum of Pload and Pbat is not greater than Pg (NO), the switchover command generation unit 10 ends the switchover process. In step S03, if the sum of Pload and Pbat is greater than Pg (YES), the switchover command generation unit 10 proceeds to step S04. Here, regarding Pg, a direction of flowing from the power generation device 5 to the DC grid 50 is defined as plus; regarding Pload, a direction of flowing from the DC grid 50 to the load DC-DC converter 30 side is defined as plus; and regarding Pbat, a direction of flowing from the DC grid 50 to the DC power supply DC-DC converter 40 side (charging direction) is defined as plus. In a case where Pg<Pload+Pbat is satisfied, reverse power flow operation to the AC input grid 2 does not occur and there is no problem if the operation mode 1 is switched. Therefore, the switchover command generation unit 10 proceeds to step S04.

The determination in step S03 is processing of determining whether or not reverse power flow operation occurs. Therefore, whether or not reverse power flow operation is occurring may be determined from output power Pacdc of the AC-DC converter 20 detected by the first sensor 51 provided between the AC-DC converter 20 and the DC grid 50.

The powers used in step S03 are values that have undergone filtering for removing an influence such as noise. In a case of not using values that have undergone filtering, it is preferable to use values from which an influence of noise has been removed, e.g., average values over a certain period.

In step S04, the switchover command generation unit determines whether or not a state of charge SOC of the secondary battery which is the DC power supply 4 is greater than a first threshold SOCth1 for the remaining capacity. Here, the first threshold SOCth1 for the remaining capacity is set at 80% of the capacity in a full-charge state, for example. In step S04, if SOC is not greater than SOCth1 (NO), the switchover command generation unit 10 ends the switchover process. In step S04, if SOC is greater than SOCth1 (YES), the switchover command generation unit 10 proceeds to step S05.

Subsequent processing from step S05 is processing for switching the operation mode from the operation mode 1 to the operation mode 2. In step S05, the DC grid voltage command generation unit 29 calculates an optimum value for the DC grid voltage command Vref. Several methods are conceivable for calculating an optimum value for the DC grid voltage command Vref. For example, loss characteristics in power conversion in the AC-DC converter 20, the load DC-DC converter 30, and the DC power supply DC-DC converter 40 may be stored in advance and the loss characteristics may be used for calculation. Specifically, the DC power distribution system 1 includes a storage unit, and functions representing loss characteristics with respect to variables which are power information (input power information or output power information) of the AC-DC converter 20, the load DC-DC converter 30, and the DC power supply DC-DC converter 40 are stored in the storage unit. A plurality of such functions are prepared for each DC grid voltage. By using these functions, it becomes possible to calculate losses in the respective converters when powers and the DC grid voltage are known. Accordingly, while the DC grid voltage is changed, loss of each converter is calculated, and the DC grid voltage that minimizes the sum of losses can be used as an optimum value for Vref. At this time, information about the wiring impedance of the DC grid may also be stored and the value of current flowing through the DC grid may be calculated by dividing the detected power value by the voltage value of the DC grid. With the calculated value of flowing current of the DC grid, loss in the DC grid due to the wiring impedance is calculated, whereby an optimum value for Vref can be calculated.

As a simple way, the higher one of the load supply voltage to the load 3 and the voltage of the DC power supply 4 may be set as Vref. Thus, it is possible to reduce the step-down ratio from the DC grid voltage to the load 3 and the DC power supply 4. Alternatively, an optimum value for Vref may be set using hill climbing or the like so as to minimize a value of Pacdc+Pg−(Pload+Pbat), while Vref is actually varied.

Next, in step S06, the switchover command generation unit 10 determines whether or not the DC grid voltage command Vref calculated in step S05 is smaller than operation lower limit voltage Vlim_low of the AC-DC converter 20. In step S06, if Vref is smaller than Vlim_low (YES), in step S07, the switchover command generation unit 10 stops operation of the AC-DC converter 20. By the switchover command generation unit 10 stopping operation of the AC-DC converter 20, stand-alone operation of the DC power supply DC-DC converter 40 can be started in step S08 and thus DC grid voltage corresponding to Vref calculated in step S05 can be achieved. Here, the stand-alone operation of the DC power supply DC-DC converter 40 means that the DC power supply DC-DC converter 40 is controlling charge/discharge power for the DC power supply 4 so as to control the DC grid voltage. A difference from the autonomous operation will be described. In the autonomous operation, while the AC-DC converter 20 is controlling the DC grid voltage, if the DC grid voltage goes outside a certain range (voltage range from Vc to Vd), the DC power supply DC-DC converter 40 increases/decreases the power command Pbat_ref given thereto, thus performing operation so as not to deviate from the voltage range from VH to VL. On the other hand, in the stand-alone operation, the AC-DC converter 20 is not controlling the DC grid voltage. The DC power supply DC-DC converter 40 controls the DC grid voltage and performs charging/discharging of power needed for keeping the DC grid voltage at command voltage.

In the stand-alone operation of the DC power supply DC-DC converter 40 performed here, the operation manner needs to be changed from that in the autonomous operation performed when the DC grid voltage has become smaller than the threshold voltage Vd in the operation mode 1. In the autonomous operation performed when the DC grid voltage has become smaller than the threshold voltage Vd in the operation mode 1, the DC power supply DC-DC converter 40 controls the DC grid voltage to be Vd, whereas in the stand-alone operation in the operation mode 2, the DC power supply DC-DC converter 40 needs to control the DC grid voltage to be Vref. In the operation mode 1, if the DC grid voltage is steady voltage, the DC power supply DC-DC converter 40 is in a heteronomous operation state of performing charging/discharging in accordance with the charge/discharge power command value, and the DC grid voltage is controlled by the AC-DC converter 20.

When operation of the AC-DC converter 20 is stopped and stand-alone operation of the DC power supply DC-DC converter 40 is started through step S07 and step S08, it is necessary to mechanically cut off electric connection between the AC-DC converter 20 and the DC grid 50 so that power is not supplied from the AC-DC converter 20 to the DC grid 50. If electric connection between the AC-DC converter 20 and the DC grid 50 is not cut off, for example, when voltage of the DC grid 50 is smaller than a value obtained by multiplying the effective value voltage of the AC input grid 2 by the square root of 2, power is supplied from the AC input grid 2 to the DC grid 50 via a parasitic diode that a switching semiconductor element of the AC-DC converter 20 has, a diode connected in parallel to the switching semiconductor element, or the like, so that voltage of the DC grid 50 increases.

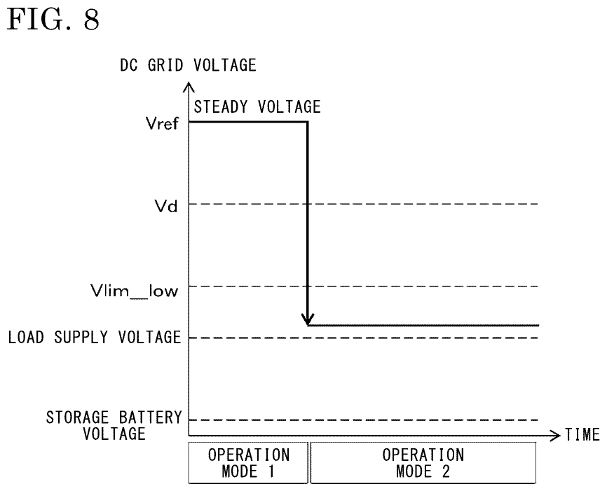

FIG. 8 illustrates the switchover process for the operation mode in the DC power distribution system of the present embodiment. FIG. 8 shows the DC grid voltage command Vref in the switchover process from step S06 to step S08 in FIG. 7. In FIG. 8, the horizontal axis indicates time and the vertical axis indicates voltage. As shown in FIG. 8, when Vref calculated in step S05 is smaller than Vlim_low, stand-alone operation of the DC power supply DC-DC converter 40 is started.

In step S06, if Vref is not smaller than Vlim_low (NO), the switchover command generation unit 10 continues operation of the AC-DC converter 20. Therefore, stand-alone operation of the DC power supply DC-DC converter 40 is not started. At this time, if the relationship among the threshold voltage Vd for stand-alone operation of the DC power supply DC-DC converter 40, Vref, and the operation lower limit voltage Vlim_low of the AC-DC converter 20 is Vd≥Vref≥Vlim_low, the DC power supply DC-DC converter 40 might switch to stand-alone operation. Accordingly, the switchover command generation unit 10 changes Vd to a value smaller than Vref, in step S09.

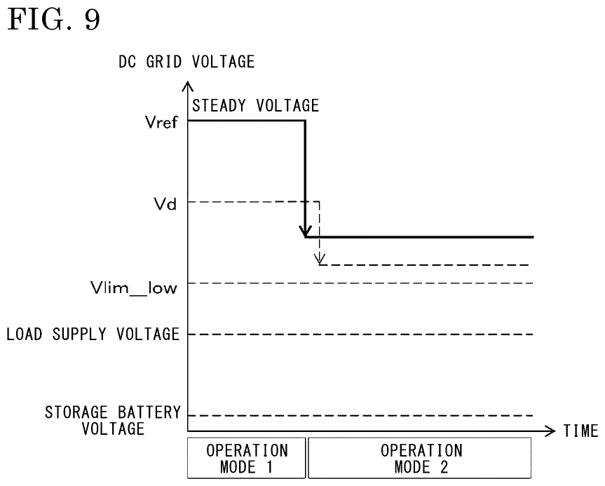

FIG. 9 illustrates the switchover process for an operation mode in the DC power distribution system of the present embodiment. FIG. 9 shows the DC grid voltage command Vref and the threshold voltage Vd for stand-alone operation of the DC power supply DC-DC converter 40 in the switchover process from step S06 to step S09 in FIG. 7. In FIG. 9, the horizontal axis indicates time and the vertical axis indicates voltage. As shown in FIG. 9, by changing Vd to a value smaller than Vref, it becomes possible to prevent the DC power supply DC-DC converter 40 from switching to stand-alone operation.

Next, a procedure for switchover from the operation mode 2 to the operation mode 1 in the DC power distribution system 1 of the present embodiment will be described. In the following description, it is assumed that the DC power supply 4 is formed by a secondary battery.

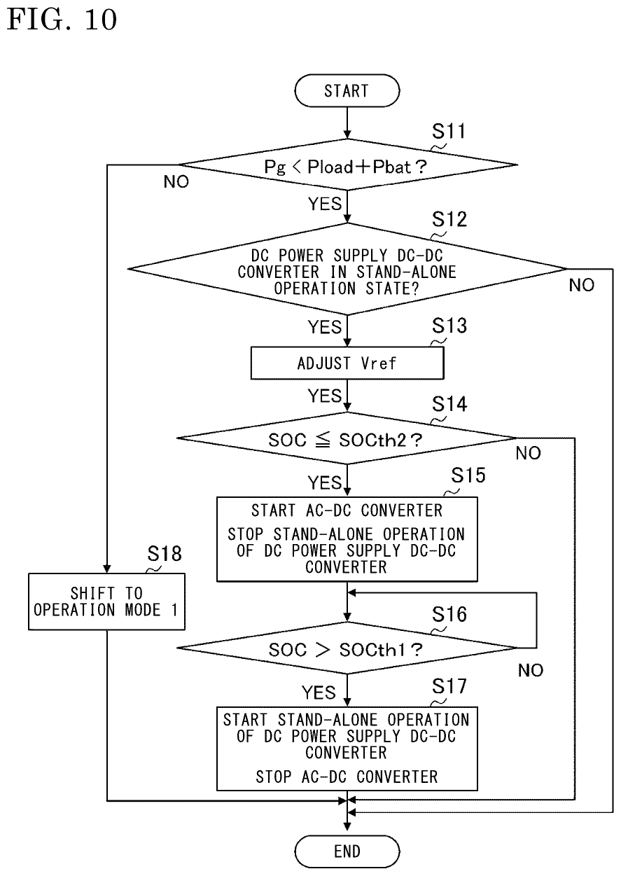

FIG. 10 is a flowchart showing a switchover process for the operation mode in the DC power distribution system 1 of the present embodiment. The switchover process for the operation mode shown in FIG. 10 is a process for switching from the operation mode 2 to the operation mode 1. After the process is started, in step S11, the switchover command generation unit 10 determines whether or not the sum of load power Pload supplied to the load DC-DC converter 30 and the load 3, which is detected by the second sensor 52, and charge/discharge power Pbat supplied to the DC power supply DC-DC converter 40 and the DC power supply 4, which is detected by the third sensor 53, is greater than generated power Pg of the power generation device 5 detected by the first sensor 51. In step S11, if the sum of Pload and Pbat is not greater than Pg (NO), the switchover command generation unit 10 proceeds to step S18. In step S18, the switchover command generation unit 10 shifts the operation mode to the operation mode 1 and ends the switchover process. In switchover to the operation mode 1, in a case where the DC power supply DC-DC converter 40 is performing stand-alone operation, first, the DC grid voltage command generation unit 29 increases Vref toward a voltage value greater than the operation lower limit voltage Vlim_low of the AC-DC converter 20. The purpose of this is to increase the DC grid voltage to a value not smaller than Vlim_low before starting the AC-DC converter 20. Thereafter, the AC-DC converter 20 is started and stand-alone operation of the DC power supply DC-DC converter 40 is stopped. In a case where the DC power supply DC-DC converter 40 is not performing stand-alone operation, the DC grid voltage command Vref for the AC-DC converter 20 is returned to steady voltage, whereby switchover to the operation mode 1 is completed.

As the generated power Pg and the load power Pload in step S11, time-series predictive generated power and time-series predictive load power may be used, respectively. By using predictive powers, it is possible to switch the operation mode before increase in Pg, decrease in Pload, or the like actually occurs. For example, by using time-series predictive powers in step S11, it is possible to perform, in advance, switchover from a time period in which generated power in solar power generation is small and power consumption of the load is small during the night to a time period in which generated power in solar power generation and power consumption of the load both increase in the morning. Thus, provided is an effect of preventing occurrence of a phenomenon in which the DC grid voltage sharply increases by generated power in solar power generation during switchover to the operation mode 1 and thus solar power generation is suppressed, or a phenomenon in which the DC grid voltage becomes overvoltage and thus the DC power distribution system stops. In step S11, if the sum of Pload and Pbat is greater than Pg (YES), the switchover command generation unit 10 proceeds to step S12.

In step S12, the switchover command generation unit 10 determines whether or not the DC power supply DC-DC converter 40 is in a stand-alone operation state. The determination in step S12 can be performed by reading the operation state of the DC power supply DC-DC converter 40 stored in a storage unit or the like. In step S12, if the DC power supply DC-DC converter 40 is not in a stand-alone operation state (NO), the switchover command generation unit 10 ends the switchover process. In step S12, if the DC power supply DC-DC converter 40 is in a stand-alone operation state (YES), the switchover command generation unit 10 proceeds to step S13.

In step S13, the DC grid voltage command generation unit 29 adjusts Vref on the basis of the remaining capacity of the DC power supply 4. Specifically, the DC grid voltage command generation unit 29 increases Vref toward a voltage value greater than the operation lower limit voltage Vlim_low of the AC-DC converter 20 as the remaining capacity of the DC power supply 4 decreases and the SOC decreases. The purpose of this adjustment is to increase the DC grid voltage to a value not smaller than Vlim_low because the AC-DC converter 20 needs to be started when the remaining capacity of the DC power supply 4 has become small.

In step S14, the switchover command generation unit 10 determines whether or not the state of charge SOC of the secondary battery which is the DC power supply 4 is equal to or smaller than a second threshold SOCth2 for the remaining capacity. Here, the second threshold SOCth2 for the remaining capacity is set at 20% of the capacity in a full-charge state, for example. In step S14, if SOC is greater than SOCth2 (NO), the switchover command generation unit 10 ends the switchover process. In step S14, if SOC is not greater than SOCth2 (YES), the switchover command generation unit 10 proceeds to step S15. In the case where the state of charge SOC is not greater than the second threshold SOCth2 for the remaining capacity, it can be determined that it is necessary to charge the DC power supply 4 from the DC grid 50.

In step S15, the switchover command generation unit 10 starts the AC-DC converter 20. Then, the switchover command generation unit 10 stops stand-alone operation of the DC power supply DC-DC converter 40. Further, the switchover command generation unit 10 controls Pbat_ref so as to charge the DC power supply 4. Through this operation, the DC power distribution system 1 charges the DC power supply 4 using power inputted from the AC input grid 2 and supplies power to the load 3 at the same time.

In step S16, the switchover command generation unit 10 determines whether or not the state of charge SOC of the secondary battery which is the DC power supply 4 is greater than the first threshold SOCth1 for the remaining capacity. In step S16, if SOC is not greater than SOCth1 (NO), the switchover command generation unit 10 returns to step S16. In step S16, if SOC is greater than SOCth1 (YES), the switchover command generation unit 10 proceeds to step S17.

In step S17, the switchover command generation unit starts stand-alone operation of the DC power supply DC-DC converter 40 and stops the AC-DC converter 20. Thus, in processing from step S12 to step S17, the AC-DC converter 20 switches between a stopped state and an operating state in accordance with the state of charge of the DC power supply 4, i.e., the AC-DC converter 20 operates intermittently.

In the DC power distribution system configured as described above, in a case where generated power of the power generation device is smaller than power supplied from the load DC-DC converter to the load, voltage of the DC grid is reduced and the operation mode of the AC-DC converter is switched from the operation mode 1 to the operation mode 2. Thus, step-down ratios in stepping down the DC grid voltage to the load supply voltage for supplying power to the load and the charge voltage for charging the DC power supply are reduced. As a result, in the DC power distribution system of the present embodiment, even in a case where steady voltage of the DC grid voltage and the load supply voltage are greatly different from each other, the voltage of the DC grid is reduced when the generated power of the power generation device is small, whereby power loss can be reduced.

In the DC power distribution system of the present embodiment, it has been described that the power generation device is a DC power generation device such as a solar power generation device. However, the power generation device may be an AC power generation device such as a wind power generation device. In a case where the power generation device is an AC power generation device, an AC-DC converter may be provided between the power generation device and the DC grid.

### Embodiment 2

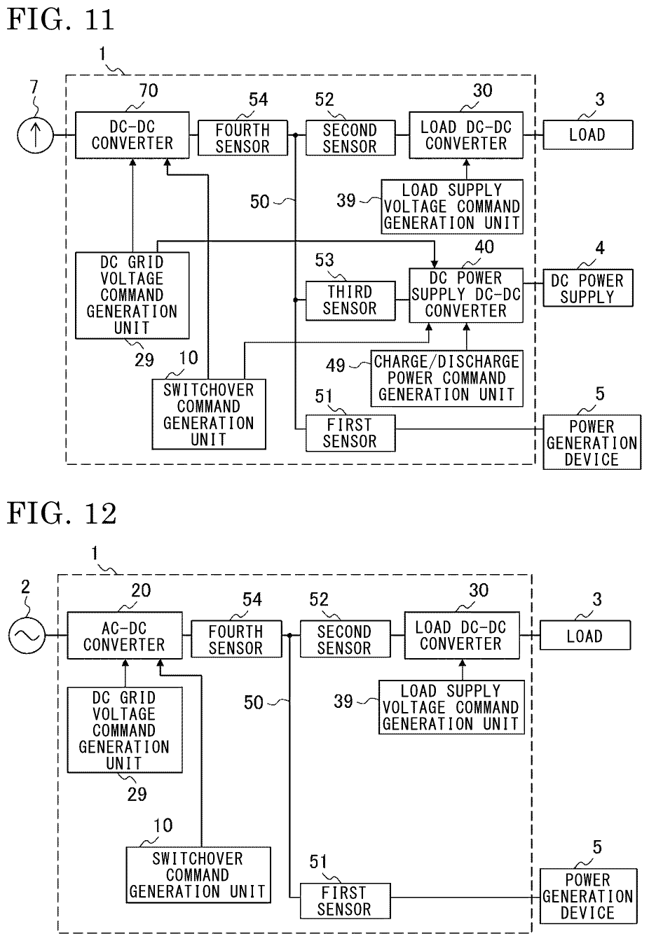

FIG. 11 is a configuration diagram of a DC power distribution system according to embodiment 2. The DC power distribution system 1 of the present embodiment is provided between a DC input grid 7, and the load 3, the DC power supply 4, and the power generation device 5. Here, the DC input grid 7 is a DC grid operated by an electric power company. As shown in FIG. 11, the DC power distribution system 1 of the present embodiment is configured such that the AC input grid 2 is replaced with the DC input grid 7 and the AC-DC converter 20 is replaced with a DC-DC converter 70 in the configuration of the DC power distribution system of embodiment 1 shown in FIG. 1. The other configurations of the DC power distribution system 1 of the present embodiment are the same as those of the DC power distribution system of embodiment 1.

The DC power distribution system 1 of the present embodiment includes the DC-DC converter 70 which converts DC power inputted from the DC input grid 7 to DC power having different voltage and outputs the DC power to the DC grid 50, the load DC-DC converter 30 provided between the DC grid 50 and the load 3, the DC power supply DC-DC converter 40 provided between the DC grid 50 and the DC power supply 4, and the switchover command generation unit 10. The load DC-DC converter 30 converts DC power from the DC grid 50 to load supply voltage for the load 3 and supplies the resultant power to the load 3. The load 3 is an electric device driven with DC voltage and includes one or a plurality of electric devices.

The DC power distribution system 1 of the present embodiment is capable of performing forward power flow operation of supplying DC power inputted from the DC input grid 7, to the load 3 and the DC power supply 4 through the DC grid 50, and reverse power flow operation of supplying DC power inputted from the DC power supply 4 and the power generation device 5, to the DC input grid 7 through the DC grid 50. In the DC power distribution system 1, forward power flow operation and reverse power flow operation are controlled by the DC-DC converter 70.

In the DC power distribution system 1 of the present embodiment, the DC-DC converter 70 may be configured as an insulation bidirectional converter. In this case, it is possible to perform reverse power flow operation irrespective of the relationship between voltage of the DC grid 50 and voltage of the DC input grid 7. However, there is a limitation on the step-up/down ratio of the DC-DC converter 70, and therefore there is a limitation on a voltage difference between the DC input grid 7 and the DC grid 50. The limitation voltage is the lower limit voltage Vlim_low in the operation mode 1. The voltage of the DC grid 50 is set to be higher than the load supply voltage of the load 3 and the charge/discharge voltage of the DC power supply 4. For example, the voltage of the DC input grid 7 is set at 1500 V, the voltage of the DC grid 50 is set at 740 V, the load supply voltage of the load 3 is set at 340 V, and the charge/discharge voltage of the DC power supply 4 is set at 300 V. The load 3 and the DC power supply 4 are supplied with powers at voltages stepped down from the voltage of the DC grid 50 by the load DC-DC converter 30 and the DC power supply DC-DC converter 40, respectively.

Switchover processes for the operation mode in the DC power distribution system 1 of the present embodiment are the same as in the flowcharts shown in FIG. 7 and FIG. 10 in embodiment 1. However, in FIG. 7 and FIG. 10, the AC-DC converter 20 needs to be replaced with the DC-DC converter 70. For example, in the DC power distribution system 1 of the present embodiment, in a case of switching from the operation mode 1 to the operation mode 2, processing of stopping the DC-DC converter 70 is performed in step S06 in FIG. 7. In addition, in a case of switching from the operation mode 2 to the operation mode 1, processing of starting the DC-DC converter 70 and stopping stand-alone operation of the DC power supply DC-DC converter 40 is performed in step S15 in FIG. 10. Similarly, processing of starting stand-alone operation of the DC power supply DC-DC converter 40 and stopping the DC-DC converter 70 is performed in step S17 in FIG. 10.

In the DC power distribution system configured as described above, in a case where generated power of the power generation device is smaller than power supplied from the load DC-DC converter to the load, voltage of the DC grid is reduced and the operation mode of the DC-DC converter is switched from the operation mode 1 to the operation mode 2. Thus, step-down ratios in stepping down the DC grid voltage to the load supply voltage for supplying power to the load and the charge voltage for charging the DC power supply are reduced. As a result, in the DC power distribution system of the present embodiment, even in a case where steady voltage of the DC grid voltage and the load supply voltage are greatly different from each other, the voltage of the DC grid is reduced when the generated power of the power generation device is small, whereby power loss can be reduced.

### Embodiment 3

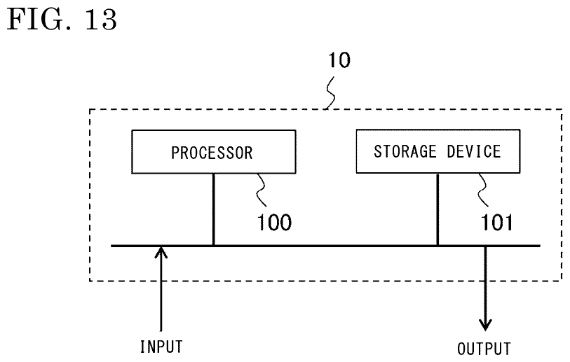

FIG. 12 is a configuration diagram of a DC power distribution system according to embodiment 3. The DC power distribution system 1 of the present embodiment is provided between the AC input grid 2, and the load 3 and the power generation device 5. As shown in FIG. 12, the DC power distribution system 1 of the present embodiment is configured such that the DC power supply DC-DC converter 40, the charge/discharge power command generation unit 49, and the third sensor 53 are removed from the configuration of the DC power distribution system of embodiment 1 shown in FIG. 1. The other configurations of the DC power distribution system 1 of the present embodiment are the same as those of the DC power distribution system of embodiment 1.

Switchover processes for the operation mode in the DC power distribution system 1 of the present embodiment are the same as in the flowcharts shown in FIG. 7 and FIG. 10 in embodiment 1. However, in FIG. 7 and FIG. 10, operation of the DC power supply DC-DC converter needs to be removed. Specifically, operation of the DC power supply DC-DC converter in step S08 in FIG. 7 is removed. In addition, operation of the DC power supply DC-DC converter in step S15 and step S17 in FIG. 10 is removed. Further, Pbat is removed in step S03 in FIG. 7 and step S11 in FIG. 10.

In the DC power distribution system of the present embodiment, Vref in the operation mode 2 needs to be greater than the operation lower limit voltage Vlim_low of the AC-DC converter 20. If the DC grid voltage is smaller than Vlim_low, operation of the AC-DC converter 20 stops. Therefore, Vref in the operation mode 2 of the DC power distribution system of the present embodiment is greater than Vref in the operation mode 2 of the DC power distribution system of embodiment 1. Thus, in the DC power distribution system of the present embodiment, the reduction amount of voltage of the DC grid when generated power of the power generation device is small is smaller than in the DC power distribution system of embodiment 1, but even in a case where steady voltage of the DC grid voltage and the load supply voltage are greatly different from each other, the voltage of the DC grid is reduced when the generated power of the power generation device is small, whereby power loss can be reduced.

The switchover command generation unit 10 is composed of a processor 100 and a storage device 101, as shown in a hardware example in FIG. 13. Although not shown, the storage device is provided with a volatile storage device such as a random access memory and a nonvolatile auxiliary storage device such as a flash memory. Instead of a flash memory, an auxiliary storage device of a hard disk may be provided. The processor 100 executes a program inputted from the storage device 101. In this case, the program is inputted from the auxiliary storage device to the processor 100 via the volatile storage device. The processor 100 may output data such as a calculation result to the volatile storage device of the storage device 101, or may store such data into the auxiliary storage device via the volatile storage device.

Although the disclosure is described above in terms of various exemplary embodiments and implementations, it should be understood that the various features, aspects, and functionality described in one or more of the individual embodiments are not limited in their applicability to the particular embodiment with which they are described, but instead can be applied, alone or in various combinations to one or more of the embodiments of the disclosure.

It is therefore understood that numerous modifications which have not been exemplified can be devised without departing from the scope of the present disclosure. For example, at least one of the constituent components may be modified, added, or eliminated. At least one of the constituent components mentioned in at least one of the preferred embodiments may be selected and combined with the constituent components mentioned in another preferred embodiment.

### DESCRIPTION OF THE REFERENCE CHARACTERS

1 DC power distribution system
2 AC input grid
3 load
4 DC power supply
5 power generation device
7 DC input grid
10 switchover command generation unit
20 AC-DC converter
21 AC-DC conversion unit
22 output voltage control unit
23 current command generation unit
24 command value filter unit
29 DC grid voltage command generation unit
30 load DC-DC converter
31 DC-DC conversion unit
32 output voltage control unit
33 command value filter unit
39 load supply voltage command generation unit
40 DC power supply DC-DC converter
41 DC-DC conversion unit
42 output voltage control unit
43 current command generation unit
44 command value filter unit
45 autonomous operation control unit
49 charge/discharge power command generation unit
50 DC grid
51 first sensor
52 second sensor
53 third sensor
54 fourth sensor
55 fifth sensor
56 sixth sensor
57 seventh sensor
58 eighth sensor
59 ninth sensor
60 tenth sensor
70 DC-DC converter
100 processor
101 storage device

1. A DC power distribution system comprising:
an AC-DC converter having a forward power flow function of converting AC power inputted from a power grid to DC power and outputting the DC power to a DC grid, and a reverse power flow function of converting DC power from the DC grid to AC power and outputting the AC power to the power grid;
a first sensor which detects generated power of a power generation device connected to the DC grid;
a load DC-DC converter which supplies power to a load connected to the DC grid;
a second sensor which detects power supplied from the DC grid to the load DC-DC converter and the load; and
a switchover command generation circuitry which generates a command for switching between two operation modes of the AC-DC converter, wherein
the two operation modes are an operation mode 1 in which the reverse power flow function of the AC-DC converter is enabled, and an operation mode 2 in which the reverse power flow function of the AC-DC converter is disabled,
in the operation mode 1, voltage of the DC grid is set to be higher than a value obtained by multiplying a voltage effective value of the AC power by a square root of 2, and
in a case where the generated power of the power generation device detected by the first sensor is smaller than the power supplied to the load DC-DC converter and the load, which is detected by the second sensor, the switchover command generation circuitry reduces the voltage of the DC grid and switches the operation mode of the AC-DC converter from the operation mode 1 to the operation mode 2.

2. The DC power distribution system according to claim 1, further comprising a DC power supply DC-DC converter which inputs/outputs charge/discharge power to/from a DC power supply connected to the DC grid, wherein
when the operation mode of the AC-DC converter is the operation mode 2, the DC power supply DC-DC converter outputs the discharge power from the DC power supply to the DC grid.

3. The DC power distribution system according to claim 2, wherein
a first threshold for a remaining capacity of the DC power supply and a second threshold smaller than the first threshold are set in advance, and
in a state in which the operation mode of the AC-DC converter is the operation mode 2, if the remaining capacity of the DC power supply is greater than the first threshold, the AC-DC converter is stopped, and if the remaining capacity of the DC power supply is not greater than the second threshold, the AC-DC converter is started.

4. The DC power distribution system according to claim 2, wherein
the DC power supply DC-DC converter increases voltage to be outputted to the DC grid, as the remaining capacity of the DC power supply becomes smaller.

5. The DC power distribution system according to claim 2, further comprising:
a storage circuitry which stores loss characteristics in power conversion in the AC-DC converter, the load DC-DC converter, and the DC power supply DC-DC converter with respect to the voltage of the DC grid; and
a DC grid voltage command generation circuitry which generates a DC grid voltage command which is voltage to be outputted to the DC grid by the AC-DC converter, wherein
the DC grid voltage command generation circuitry generates the DC grid voltage command that minimizes a sum of losses in power conversion in the AC-DC converter, the load DC-DC converter, and the DC power supply DC-DC converter, on the basis of the loss characteristics stored in the storage circuitry.

6. The DC power distribution system according to claim 1, further comprising a storage circuitry which stores time-series predictive generated power of the power generation device and time-series predictive load power of the load, wherein
in a time period in which the predictive generated power is smaller than the predictive load power, the switchover command generation circuitry reduces the voltage of the DC grid and switches the operation mode of the AC-DC converter from the operation mode 1 to the operation mode 2.

7. A DC power distribution system comprising:
a DC-DC converter having a forward power flow function of converting DC power inputted from a power grid to DC power having different voltage and outputting the DC power to a DC grid, and a reverse power flow function of converting DC power from the DC grid to DC power having different voltage and outputting the DC power to the power grid;
a first sensor which detects generated power of a power generation device connected to the DC grid;
a load DC-DC converter which supplies power to a load connected to the DC grid;
a second sensor which detects power supplied from the DC grid to the load DC-DC converter and the load; and
a switchover command generation circuitry which generates a command for switching between two operation modes of the DC-DC converter, wherein
the two operation modes are an operation mode 1 in which the reverse power flow function of the DC-DC converter is enabled, and an operation mode 2 in which the reverse power flow function of the DC-DC converter is disabled, and
in a case where the generated power of the power generation device detected by the first sensor is smaller than the power supplied to the load DC-DC converter and the load, which is detected by the second sensor, the switchover command generation circuitry reduces the voltage of the DC grid and switches the operation mode of the DC-DC converter from the operation mode 1 to the operation mode 2.

8. The DC power distribution system according to claim 3, wherein
the DC power supply DC-DC converter increases voltage to be outputted to the DC grid, as the remaining capacity of the DC power supply becomes smaller.

9. The DC power distribution system according to claim 3, further comprising:
a storage circuitry which stores loss characteristics in power conversion in the AC-DC converter, the load DC-DC converter, and the DC power supply DC-DC converter with respect to the voltage of the DC grid; and
a DC grid voltage command generation circuitry which generates a DC grid voltage command which is voltage to be outputted to the DC grid by the AC-DC converter, wherein
the DC grid voltage command generation circuitry generates the DC grid voltage command that minimizes a sum of losses in power conversion in the AC-DC converter, the load DC-DC converter, and the DC power supply DC-DC converter, on the basis of the loss characteristics stored in the storage circuitry.

10. The DC power distribution system according to claim 4, further comprising:
a storage circuitry which stores loss characteristics in power conversion in the AC-DC converter, the load DC-DC converter, and the DC power supply DC-DC converter with respect to the voltage of the DC grid; and
a DC grid voltage command generation circuitry which generates a DC grid voltage command which is voltage to be outputted to the DC grid by the AC-DC converter, wherein
the DC grid voltage command generation circuitry generates the DC grid voltage command that minimizes a sum of losses in power conversion in the AC-DC converter, the load DC-DC converter, and the DC power supply DC-DC converter, on the basis of the loss characteristics stored in the storage circuitry.

11. The DC power distribution system according to claim 8, further comprising:
a storage circuitry which stores loss characteristics in power conversion in the AC-DC converter, the load DC-DC converter, and the DC power supply DC-DC converter with respect to the voltage of the DC grid; and
a DC grid voltage command generation circuitry which generates a DC grid voltage command which is voltage to be outputted to the DC grid by the AC-DC converter, wherein
the DC grid voltage command generation circuitry generates the DC grid voltage command that minimizes a sum of losses in power conversion in the AC-DC converter, the load DC-DC converter, and the DC power supply DC-DC converter, on the basis of the loss characteristics stored in the storage circuitry.
